(19) United States
(12) Patent Application Publication
(10) Pub. No.: US 2004/0244271 A1
(43) Pub. Date: Dec. 9, 2004

(54) Bait buddy

(76) Inventors: James A. Farmer, Chandler, AZ (US); James Buarn Farmer, Mesa, AZ (US)

Correspondence Address: JAMES A. FARMER, 99 N. COOPER RD #145, CHANDLER, AZ, 85225, US

(21) Appl. No.: 10/752,825

(22) Filed: Jun. 10, 2004

Related U.S. Application Data
(60) Provisional application No. 60/437,897, filed on Jan. 6, 2003.

(51) Int. Cl. A01K 97/00

(52) U.S. Cl. 43/55

(57) ABSTRACT

The Bait Buddy is a portable lightweight device with several separated compartments. The Bait Buddy is used to store bait for fisherman while outdoors, an example of bait would be night crawlers, dillies, bee moth, mealworms, salmon eggs, power bait, chicken livers and etc. The Bait Buddy is intended but not limited to carrying bait for just fisherman. Hunters could carry different types of animal urine and several different animal scents.

The unique aspect of The Bait Buddy is it has an internal insulated lining. This lining can be filled with liquid and frozen to keep the bait cool It can also be filled with hot liquid to warm the bait. You can also put ice packs or hot packs in the same insulated compartments, of The Bait Buddy.

I the applicant claim the benefit of my earlier provision patent application. The application No. 60/437,897, Title: The Bait Buddy, File date Jan. 6, 2003 The Bait Buddy is a portable devise with internal insulation, so it can be filled with water and frozen or filled with ice cubes, or hot water. You can also put ice packs or hot packs in the same insulated compartments of The Bait Buddy.

The purpose of the bait buddy is too cool or warm bait for fishermen while fishing outdoors. Some examples are night crawlers, dillies, bee moth; meal worms salmon eggs, power baits, red worms, chicken livers, etc. The Bait Buddy has two parts, one being the cooling or heating device, and a compartment with several drawers to hold the bait. There is a tracking system both on the cooling compartment and the bait compartment, which allows the bait compartment to slide in and out. The Bait Buddy is designed for but not limited to fishing; hunters could also carry a variety of animal scents, and animal urine in the compartments.

The Bait Buddy is a devise that has a heating or cooling compartment, and a bait compartment. The bait buddy has the ability to help cool or heat bait for people fishing outside. It has a separate cooling or heating compartment and a bait compartment. The cooling or heating compartment has a tracking system, as does the bait compartment, which allows the bait compartment to be removed. The bait container has drawers with its own tracking system, which allows the drawers to be pulled out for use and then returned.

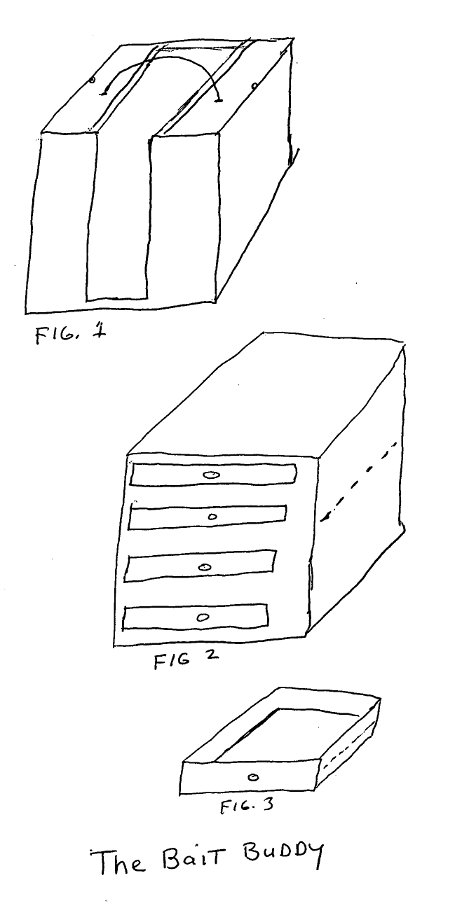

FIG. 1 shows the heating or cooling compartment, which is insulated on the inside to insulate the top, front, the sides, and back. The top has a handle for carrying, and there is a flap on each side, which opens and locks. This is where you fill the compartment up with your desired method. It can be filled with water and frozen; you can use ice, ice packs, hot water, or hot packs, etc. There is also a tracking system, which allows the bait compartment to slide in.

FIG. 2 shows the bait compartment, which has a tracking system on the side, which allows it to slide and lock into the heating or cooling system. It also can be completely removed. The bait compartment has several bait drawers to hold bait.

FIG. 3 shows the bait drawers which have there own tracking system so the can open and close. Each drawer has its own handle.

The heating or cooling compartment is made of durable lightweight plastic. The bait compartment as well as the bait drawers is also made of durable lightweight plastic.

1. I the applicant claim the benefit of my earlier provisional patent application The application No. 60/437,897, Title: The Bait Buddy, File date Jan. 6, 2003.
We claim that The Bait Buddy is a devise that has a heating or cooling compartment, and a bait compartment. The bait buddy has the ability to help cool or heat bait for people fishing outside. It has a separate cooling or heating compartment and a bait compartment. The cooling and heating compartment has a tracking system, as does the bait compartment, which allows the bait compartment to be removed. The bait container has drawers with its own tracking system, which allows the drawers to be pulled out for use and then returned.
